(19) United States
(12) Patent Application Publication
(10) Pub. No.: US 2006/0195880 A1
(43) Pub. Date: Aug. 31, 2006

(54) Service providing apparatus

(75) Inventors: Kazunaga Horiuchi, Kanagawa (JP); Takashi Isozaki, Kanagawa (JP); Hirotsugu Kashimura, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/198,239

(22) Filed: Aug. 8, 2005

(30) Foreign Application Priority Data
Feb. 28, 2005 (JP) 2005-054499

(51) Int. Cl. H04N 7/16; H04N 7/173; H04N 7/10; H04N 7/025

(52) U.S. Cl. 725/116; 725/146; 725/34; 725/35

(57) ABSTRACT

A service providing apparatus in which a learning control unit performs control as to whether or not to perform learning of a first estimation unit based on an output of an environment decision unit for outputting information about environment of a user and outputs of the first estimation unit and a second estimation unit for making stochastic decisions on service targeted for supply.

### BACKGROUND OF THE INVENTION

1. Field of the Invention

The present invention relates to an apparatus for providing service such as automatic adjustment to a device used by a user or presentation of information to the user.

2. Description of the Related Art

In recent years, the amount of information which an individual person can treat every day has increasingly grown with explosive prevalence of computer networks. As a specific example, under present circumstances, the amount of electronic mail which an individual person receives for a day has also increased more significantly than ever before. Against such a background, the following problem also arises in recent years. That is, such a large amount of information commonly includes both of information useful and information useless for a user of a computer. On the other hand, the amount of information is increasing as described above, so that work to select useful information from these large amounts of information for a user also tends to increase.

Therefore, many information processing techniques for stochastically estimating timing of presentation or an importance level of information using a network model called a Bayesian network for the purpose of timely providing useful information or selectively presenting significant information from such information have been developed in recent years. One example of the techniques is shown in WO2001/069432.

Also, an example in which an importance level of information to be presented is estimated before presentation and also it is checked whether or not a user has treated the information as important information after presentation and learning processing of a network model using estimation processing of the importance level is performed is disclosed in WO2000/026827.

### SUMMARY OF THE INVENTION

However, in the conventional information processing techniques using, for example, the Bayesian network described above, unless learning processing for estimating an importance level of information is performed continuously, for example, handling with respect to electronic mail newly received cannot be performed. On the other hand, by continuously performing the learning processing, for example, when a user is accidentally busy and carelessly treats the electronic mail regarded as importance in a normal state, the fact is reflected on the learning and it may be wrongly determined that similar electronic mail is not important subsequently.

Thus, in the conventional techniques, attention as to whether or not to be in a state of doing learning was not paid and it was difficult to improve accuracy of the learning.

Also, such a problem is not limited to presentation of information such as electronic mail, and is expected also in the case of performing learning control in order to automatically adjust a device for providing various services of air conditioning temperature or brightness of a room. When a user shows a reaction different from a normal reaction in the case of automatically adjusting and learning such a device by sensing a user or environment, that fact is reflected on the learning, so that subsequent control may become improper.

The present invention provides a service providing apparatus capable of improving accuracy of learning.

According to a first aspect of the invention, there is provided a service providing apparatus including: a service providing unit that provides a service to a user; a first estimation unit that calculates a first occurrence probability of a predetermined event about the service using a learned result that was learned based on information about the service provided in the past and an occurrence history of the predetermined event, and providing a first determination information related to the first occurrence probability to the user; an environment decision unit that obtains information about environment of the user, classifies environment indicated by the obtained information into any of predetermined environment types according to a predetermined rule, and outputs classification result information indicating the classification result; a second estimation unit that obtains information about reaction of the user who received the service, calculates a second occurrence probability of the predetermined event about the provided service using the learned result and the obtained information, and generates second determination information related to the second occurrence probability; and a decision unit that decides whether or not to perform learning of the first estimation unit using the occurrence history of the predetermined event and the information about the provided service, based on the first determination information, the classification result information and the second determination information, wherein the first estimation unit performs learning using the occurrence history of the predetermined event and the provided service in accordance with a decision of the decision unit.

According to a second aspect of the invention, there is provided a service providing method for providing predetermined service to a user, the method including: calculating a first occurrence probability of a predetermined event about provided service using a learned result that was learned based on information about the service provided in the past and an occurrence history of the predetermined event; generating first determination information related to the first occurrence probability; obtaining information about environment of the user; classifying environment indicated by the information about environment into any of predetermined environment types according to a predetermined rule; generating classification result information indicating the classification result; obtaining information about reaction of the user receiving the service; calculating a second occurrence probability of a predetermined event about the provided service using the learned result and the information about reaction, and generating second determination information related to the second occurrence probability; deciding whether or not to perform learning about the step of generating the first determination information based on the first determination information, the classification result information and the second determination information; and learning about the step of generating the first determination information in accordance with a result of the decision.

According to a third aspect of the invention, there is provided a computer-readable program product for causing a computer system to perform procedure for providing predetermined service to a user, the procedure including: calculating a first occurrence probability of a predetermined event about provided service using a learned result that was learned based on information about the service provided in the past and an occurrence history of the predetermined event; generating first determination information related to the first occurrence probability; obtaining information about environment of the user; classifying environment indicated by the information about environment into any of predetermined environment types according to a predetermined rule; generating classification result information indicating the classification result; obtaining information about reaction of the user receiving the service; calculating a second occurrence probability of a predetermined event about the provided service using the learned result and the information about reaction, and generating second determination information related to a result of the calculation; deciding whether or not to perform learning about the step of generating the first determination information based on the first determination information, the classification result information and the second determination information; and learning about the step of generating the first determination information in accordance with a result of the decision.

### BRIEF DESCRIPTION OF THE DRAWINGS

In the accompanying drawings:

FIG. 1 is a configuration block diagram showing an example of a service providing apparatus according to an embodiment of the invention;

FIG. 2 is a functional block diagram showing one example of the service providing apparatus according to the embodiment of the invention; and

FIG. 3 is an explanatory diagram showing an information example about the contents of processing of a learning control unit.

### DETAILED DESCRIPTION OF THE PREFERRED EMBODIMENT

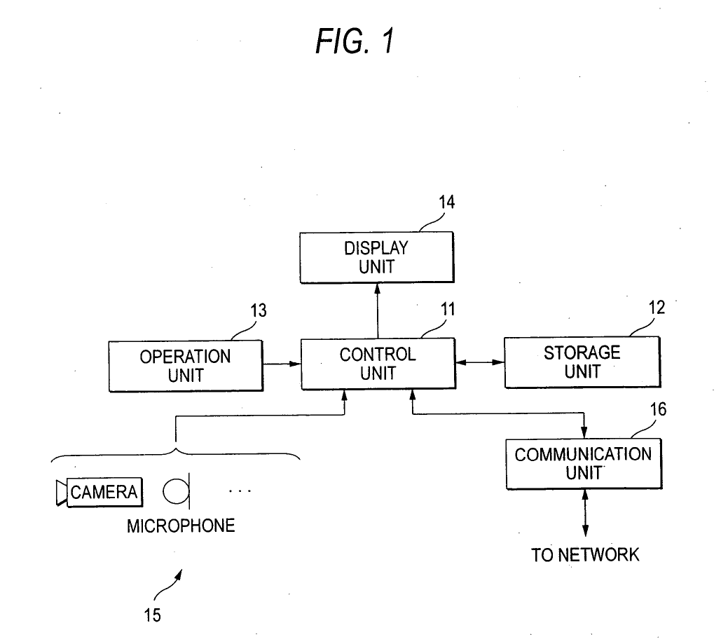

An embodiment of the invention will be described with reference to the drawings. A service providing apparatus according to the embodiment of the invention is configured to include a control unit 11, a storage unit 12, an operation unit 13, a display unit 14, a state sensor group 15 and a communication unit 16 as shown in FIG. 1. Hereinbelow, description will be made by taking the case of doing service for presenting information such as electronic mail as provided service as an example. That is, the service providing apparatus according to the embodiment operates as an information presentation apparatus.

In the embodiment, the units shown in FIG. 1 as a whole serve as a service providing unit that provides a service to a user.

The control unit 11 is, for example, a microprocessor (CPU) and operates according to a program stored in the storage unit 12. In the present embodiment, the control unit 11 executes processing serving as a first estimation unit, an environment decision unit, a second estimation unit and a decision unit of the invention. The contents of specific processing of the control unit 11 will be described below in detail.

The storage unit 12 is configured to include a memory element such as RAM or ROM, and/or a disk device, etc. A program executed by the control unit 11 is stored in the storage unit 12. Also, the storage unit 12 operates as work memory of the control unit 11. As described below, a network learned and acquired is held in the storage unit 12 of the embodiment.

The operation unit 13 is a input device such as a keyboard or a mouse and an instruction operation of a user is accepted and the contents of the instruction operation are outputted to the control unit 11. The display unit 14 displays information such as electronic mail to present the information according to instructions inputted from the control unit 11.

The state sensor group 15 includes sensors for measuring behavior, body temperature or heartbeat of a user and other environment information, for example, a camera or an infrared sensor. The sensors included in the state sensor group 15 output the information measured respectively as environment information. Incidentally, the state sensor group 15 is not necessarily required.

The communication unit 16 is a network card or a wireless LAN card, and sends out information through a network according to instructions inputted from the control unit 11. Also, the communication unit 16 receives information coming through the network and outputs the information to the control unit 11.

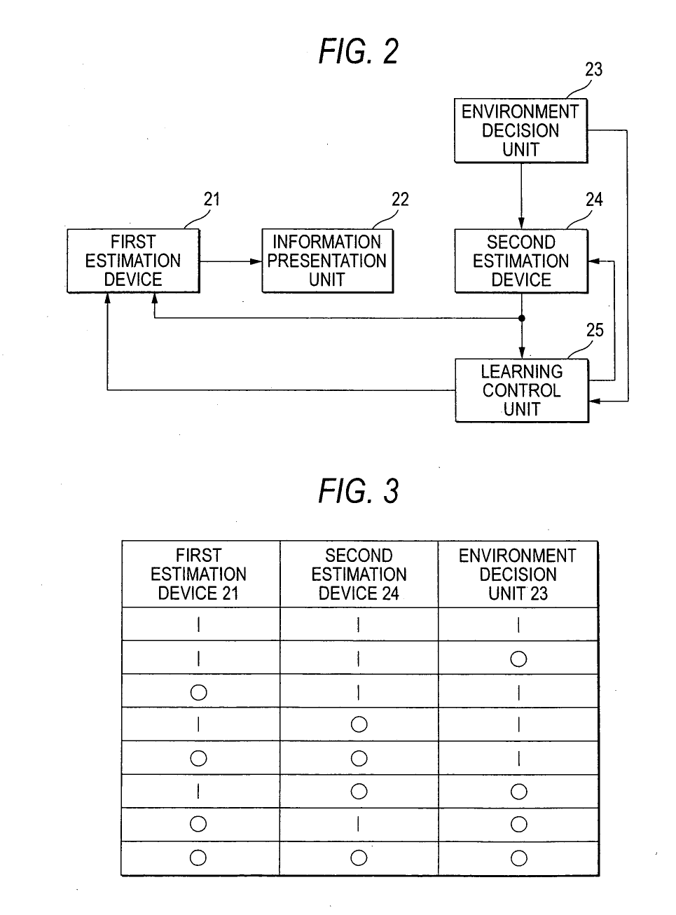

Here, the contents of processing executed by the control unit 11 will be described. The processing executed by the control unit 11 is functionally configured to include a first estimation device 21, an information presentation unit 22, an environment decision unit 23, a second estimation device 24 and a learning control unit 25 as shown in FIG. 2. In the following description, for ease of description, it is assumed that information targeted for presentation is information about electronic mail and decision information generated by the first estimation device 21 etc. is information about an importance level of the electronic mail.

When the control unit 11 receives electronic mail, the electronic mail is stored in the storage unit 12. Then, the first estimation device 21 generates determination information indicating an importance level of the electronic mail received. In the embodiment, it is assumed that the first estimation device 21 makes a decision on the importance level using a Bayesian network. Here, the method itself for deciding an importance level etc. of information using the Bayesian network is widely known, so that the details are omitted, but as a specific example herein, it is assumed that a portion of plural predetermined node (learning element information) candidates are used as the nodes of the Bayesian network.

In other words, the first estimation device 21 sets a sender name of the electronic mail received, a sender address, a sender category (for example, when a user classifies the senders by referring to address book information, information about the classification), a character string included in a title or text (the presence or absence of representation showing the date such as “X month X day” or the presence or absence of a predetermined keyword, etc.), the date of sending, etc. at the node candidates. The first estimation device 21 forms the Bayesian network (network about a causal relation between occurrences of each of the nodes) using plural nodes selected from among these node candidates. In the embodiment, each of the parameters related to the Bayesian network, information as to which node is selected from the node candidates, and a network structure between the nodes are targeted for learning processing.

That is, the first estimation device 21 forms the Bayesian network based on validity of the past decision result (occurrence history) and a relation between occurrences of each of the nodes about the electronic mail received in the past. Then, the first estimation device 21 obtains an occurrence probability of an event that a user decides that the electronic mail received by the control unit 11 is important mail, and in the case of estimating that the user decides that it is the important mail, determination information that it is the important mail is outputted to the information presentation unit 22.

The information presentation unit 22 outputs the received electronic mail and the determination information inputted from the first estimation device 21 to the display unit 14, and presents the electronic mail and the determination information to a user. Incidentally, the received electronic mail may be presented as it is when the determination information is not inputted from the first estimation device 21, and processing may be ended without presenting the electronic mail when the determination information that it is the important mail is not inputted.

Based on instruction operations of a user inputted from the operation unit 13 or environment information etc. inputted from the state sensor group 15, the environment decision unit 23 classifies environment of the user into any of predetermined environment types and generates classification result information indicating the classification result. As a specific example, the environment types herein could be classified into a type in which the user “is in a normal state” and a type in which the user “is not in a normal state”. For example, the environment decision unit 23 checks whether or not a user sits to perform an operation from information inputted from the state sensor group 15 when an instruction operation about electronic mail is inputted from the operation unit 13. Then, when the user does not sit to perform the operation, it is decided that the user “is not in a normal state”, and when the user sits to perform the operation, it is decided that the user “is in a normal state”. Incidentally, the decision as to whether or not to sit may be made by a sensor attached to a chair or may be made by performing image processing for estimating an attitude of the user from video of the user imaged by a camera.

Incidentally, the Bayesian network may be used also in the decision of the environment decision unit 23. That is, it may be decided whether or not the user “is in a normal state” using each occurrence relation of an operation speed about an operation input, the number of operation errors (for example, the number of depressions of a delete key) whether or not to sit, the presence or absence of utterance at the time of opening electronic mail, the presence or absence of movement of an eye (capable of being implemented by image processing for recognizing a portion of the eye from an image imaged by a camera), etc.

Further, the environment decision unit 23 may offer information stored in the storage unit 12 to the decision as to whether or not the user “is in a normal state”. For example, when schedule information about the user is stored in the storage unit 12, occurrence relations as to whether or not the user “is in a state before going out”, whether or not the user “is just about to return from the field”, etc. may be decided by referring to the schedule information and information about a clock (not shown) (the clock for timing the present time and date).

In a manner similar to the environment decision unit 23, based on instruction operations of a user inputted from the operation unit 13 or environment information etc. inputted from the state sensor group 15, the second estimation device 24 estimates whether or not the user decides that presented information is important, and outputs second determination information indicating a result of the estimation.

In the embodiment, it is assumed that the second estimation device 24 also makes a decision on an importance level using the Bayesian network. It is assumed that the second estimation device 24 also uses a portion of plural predetermined node candidates as the nodes of the Bayesian network.

The second estimation device 24 forms the Bayesian network (network about a causal relation between occurrences of each of the nodes) using plural nodes selected from node candidates corresponding to reaction of the user, for example, the instruction operations of the user inputted from the operation unit 13 or the environment information inputted from the state sensor group 15 and node candidates corresponding to information extracted from electronic mail presented, for example, a sender name of the electronic mail received, a sender address, a sender category (for example, when the user classifies the senders by referring to address book information, information about the classification), a character string included in a title or text (the presence or absence of representation showing the date such as “X month X day” or the presence or absence of a predetermined keyword, etc.) , or the date of sending. In the embodiment, each of the parameters related to the Bayesian network, information as to which node is selected from the node candidates, and a network structure between the nodes are targeted for learning processing.

That is, the second estimation device 24 forms the Bayesian network based on the past decision result (occurrence history) and a relation between occurrences of each of the nodes about the electronic mail received in the past. Then, the second estimation device 24 obtains an occurrence probability of an event that a user decides that the electronic mail received by the control unit 11 is important mail, and the decision result about the event is outputted as second determination information.

Incidentally, the control unit 11 may associate information fundamental to learning in these first estimation device 21, second estimation device 24 and environment decision unit 23, namely, information about the electronic mail, information about the instruction operations of the user, environment information, etc. with the received electronic mail and may hold the information in the storage unit 12 as data for the past learning.

The learning control unit 25 decides whether or not to perform learning of the first estimation device 21 or the second estimation device 24 using the presented information based on the information outputted by each of the first estimation device 21, the environment decision unit 23 and the second estimation device 24.

In the embodiment, a determination that “A: electronic mail to be presented is important” or a determination that “B: electronic mail to be presented is not important” is made as a determination of the first estimation device 21. Also, a determination that “A: the presented electronic mail was treated as important” or a determination that “B: the presented electronic mail was not treated as important” is made as a determination of the second estimation device 24.

The learning control unit 25 first checks whether or not a determination result of the first estimation device 21 matches with a determination result of the second estimation device 24. Next, when these results do not match, a parameter of the Bayesian network of the second estimation device 24 is changed by referring to the contents of instruction operations of a user or environment information, etc. For example, in the case of deciding that the user “is in a state before going out” by the environment information, an occurrence probability of “the number of operation errors” among nodes of the Bayesian network of the second estimation device 24 previously associated with occurrence of the decision is controlled to increase the occurrence probability of the operation errors. Or, a Bayesian network made of the other node group excluding the node of the number of operation errors is reconfigured and using the reconfigured Bayesian network, second determination information is regenerated.

The learning control unit 25 adjusts the second estimation device 24 in the manner and checks whether or not to match with a determination result of the first estimation device 21. Then, in the case of matching, the second determination information after regeneration (after adjustment) is fed back to the first estimation device 21 and the first estimation device 21 is learned.

Thus, even when a user behaves as if electronic mail regarded as important usually from a sending source was not important by accident in a busy time zone, for example, before going out, the learning control unit 25 adjusts the second estimation device 24 for determining the behavior and controls its determination result, so that opportunity of reflecting a temporary situation based on an accidental factor on learning decreases and accuracy of the learning can be improved.

When the regenerated second determination information is still different from the determination information outputted by the first estimation device 21, the learning control unit 25 further makes the first estimation device 21, the second estimation device 24 and the environment decision unit 23 compare information used for the presented electronic mail with each of the past learning results.

For example, in the first estimation device 21, distribution of occurrence probability of each of the nodes as the past learning result is compared with an occurrence relation corresponding to each of the nodes about the presented electronic mail. Then, when the product of probabilities corresponding to each of the occurrence relations becomes a predetermined threshold value or more, it is decided that information about the electronic mail is within the past learning. For example, it is assumed that the probability that a sender of electronic mail is A is pA and the probability that the sending time of electronic mail is within 8 a.m. to 10 a.m. is p. When it is assumed that the received electronic mail is mail sent at 6 a.m. by the sender A in the case, pA times (1-pB) is calculated and it is checked whether or not the exceeds the predetermined threshold value. According to the, when there is a high probability that the sender of electronic mail is not A from the past instances, pA becomes low. In other words, there is a high probability that an event of receiving electronic mail from the sender A is beyond the past learning instances. Thus, it is determined whether or not the presented electronic mail is within the past learning. Similar determination is made also in the second estimation device 24 and the environment decision unit 23.

The learning control unit 25 receives an input of a result in which each of the first estimation device 21, the second estimation device 24 and the environment decision unit 23 compares information used for the presented electronic mail with the past learning results. The result is either a result of being within learning (I) or a result of being beyond learning (O), respectively, and makes any of eight combinations as shown in FIG. 3.

The learning control unit 25 executes processing set every each of the combinations depending on which combination is obtained. As a specific example, first, when all are within learning as shown in the first combination, learning of the first estimation device 21 is done using second determination information outputted by the second estimation device 24. Incidentally, in the following description, the result as to which combination is obtained is represented as (III) etc. by arranging the determination results of the first estimation device 21, the second estimation device 24 and the environment decision unit 23 in the order.

Also, when it is (IIO) as shown in the second combination, it can be decided that unforeseen circumstances occur in environment information etc. In order to make a decision according to such a case, the learning control unit 25 determines whether or not to perform learning according to a predetermined rule based on conditions about reaction of a user, for example, instruction operations of the user inputted from the operation unit 13 or environment information inputted from the state sensor group 15. For example, when it is in a state in which “errors are many” in the instruction operation of the user and “the user is not busy” in the environment information, a rule etc. of doing learning are predetermined and held in the storage unit 12 and it could be determined whether or not to perform learning according to the rule.

Also, when it is in a state which is not determined in the rule, a node which has a high occurrence probability and occurs or a node which has a low occurrence probability and does not occur (hereinafter called an occurrence conformable node) is retrieved from nodes included in the Bayesian network of the environment decision unit 23. The node is a node inconsistent with the past learning data. The learning control unit 25 checks whether or not the node is a node about information extracted from electronic mail. Then, when it is such a node, the node is added to at least one of the Bayesian networks of the first estimation device 21 and the second estimation device 24. Also, when it is not such a node, the node is added to the Bayesian network of the second estimation device 24. In the case, learning may be done again based on the past learning data when the past learning data is stored in the storage unit 12.

Further, when any one of the first estimation device 21 and the second estimation device 24 decides that it is beyond learning while the environment decision unit 23 decides that it is within learning, that is, it is any of (OII), (IOI) and (OOI) as shown in the third, fourth and fifth combinations of FIG. 3, it can be decided that unforeseen circumstances do not occur in environment information etc. In the case, learning of the first estimation device 21 or the second estimation device 24 is doubtful. An occurrence conformable node is retrieved from node candidates which are not selected (not used) and are node candidates about the Bayesian network of the first estimation device 21 or the second estimation device 24. The node is a node inconsistent with the past learning data. When there is the occurrence conformable node, the learning control unit 25 adds its node to at least one of the Bayesian networks of the first estimation device 21 and the second estimation device 24. In the case, learning may be done again based on the past learning data when the past learning data is stored in the storage unit 12.

When the learning is again done thus, the Bayesian network before the learning is again done is also saved and held into the storage unit 12, and second determination information and determination information about the received electronic mail are generated with respect to the first estimation device 21 and the second estimation device 24 after the learning is again done, and it is checked whether or not the pieces of determination information match. Then, when accuracy degrades, for example, in the case that they do not match or the case that a difference between occurrence probabilities of events that a user decides that it is important becomes larger than that before the learning is again done, the Bayesian network saved and held is read out and is returned to the origin. For example, when the determination information and the second determination information match, the Bayesian network after the learning is again done is used subsequently.

Further, when the Bayesian network saved is read out and is returned to the origin, a node which is included in the Bayesian network of the first estimation device 21 or the second estimation device 24 and occurs though an occurrence probability is low or a node which does not occur though an occurrence probability is high (hereinafter called an occurrence unconformable node) is retrieved. There is a high possibility that the node is a defective node. Therefore, a Bayesian network excluding the node is generated or an actual occurrence relation of the node is ignored and an occurrence relation of the node is estimated from the other nodes (or node group) and determination information or second determination information is generated by the estimated occurrence relation rather than the actual occurrence relation. That is, deletion of the node or a structure of the network is changed. Also, in the case, learning may be done again based on the past learning data when the past learning data is stored in the storage unit 12.

Then, when the learning is again done thus, the Bayesian network before deletion of the node or a structure of the network is changed is also saved and held into the storage unit 12, and second determination information and determination information about the received electronic mail are generated with respect to the first estimation device 21 and the second estimation device 24 after the learning is again done, and it is checked whether or not the pieces of determination information match. Then, when accuracy degrades, for example, in the case that they do not match or the case that a difference between occurrence probabilities of events that a user decides that it is important becomes larger than that before the learning is again done, the Bayesian network saved and held is read out and is returned to the origin. For example, when the determination information and the second determination information match, the Bayesian network after the learning is again done is used subsequently.

For example, when the determination information and the second determination information do not match even in the case of performing processing etc. for adding the occurrence conformable node or deleting the occurrence unconformable node thus, a portion of the nodes are selected from the nodes included in the Bayesian network of the environment decision unit 23 and the selected node is added to at least one of the Bayesian networks of the first estimation device 21 and the second estimation device 24 and the defective node is replaced. Here, a decision as to which node is selected may be registered previously. Also, a network in which all the nodes included in each of the Bayesian networks of the first and second estimation devices 21, 24 and the environment decision unit 23 are extracted is generated and learning is done based on the past learning data stored in the storage unit 12 and a result of the learning is compared with the networks of the first and second estimation devices 21, 24 and thereby the nodes may be selected. The node selected specifically could be set to nodes or a node group enclosing the defective node (or node group). Then, a Bayesian network in which the defective node is replaced by the selected node is generated.

Incidentally, when the defective node cannot be identified, a new node may be requested from a user or may be added based on information capable of being obtained through a network. For example, when determination information and second determination information do not match in the case of adding the new node herein, processing (that is, processing in the case of any of (IOO), (OIO) and (OOO)) similar to the case that the environment decision unit 23 decides that it is beyond learning is performed. The processing will be described below.

Further, when improvement is not obtained, for example, the determination information and the second determination information do not match yet even in the case of performing the processing, learning of the first estimation device 21 is done by an estimation result of the second estimation device 24 on trial. Then, it is calculated what extent accuracy of estimation about electronic mail received in the past is influenced by the learning. That is, determination information and second determination information outputted by each of the second estimation device 24 and the first estimation device 21 after the trial learning are compared based on the past learning data and the past electronic mail stored in the storage unit 12. Then, a probability that the determination information mismatches is checked and in the case of deciding that a minus influence on the estimation accuracy is exerted, for example, a probability of a mismatch of the determination information of the first estimation device 21 after the trial learning becomes higher than a probability of a mismatch of the determination information of the first estimation device 21 before the trial learning, the learning control unit 25 performs control so as not to do the learning of the first estimation device 21. In the case, the learning control unit 25 counts the number of performances of such control and when the count value becomes a certain value or more within a predetermined period, information for providing notification of its fact is presented to the display unit 14.

Further, when the environment decision unit 23 decides that it is beyond learning (the case of (IOO), (OIO)) as shown in the sixth and seventh combinations of FIG. 3, there is a high possibility that unforeseen circumstances occur in environment and any one of the first estimation device 21 and the second estimation device 24 decides that it is beyond learning. That is, the case is probably because a network of any one of the first estimation device 21 and the second estimation device 24 cannot cope with unforeseen circumstances.

In the case, an occurrence conformable node is retrieved from nodes included in the Bayesian network of the environment decision unit 23. Then, the learning control unit 25 checks whether or not the node is a node about information extracted from electronic mail. Then, when it is such a node, the node is added to at least one of the Bayesian networks of the first estimation device 21 and the second estimation device 24. Also, when it is not such a node, the node is added to the Bayesian network of the second estimation device 24. In the case, learning may be done again based on the past learning data when the past learning data is stored in the storage unit 12.

Also, a network in which all the nodes included in each of the Bayesian networks of the first and second estimation devices 21, 24 and the environment decision unit 23 are extracted is generated and learning is done based on the past learning data stored in the storage unit 12 and a result of the learning is compared with the networks of the first and second estimation devices 21, 24 and thereby the nodes to be added may be selected.

Further, the case of (OOO) as shown in the eighth combination of FIG. 3 corresponds to the case that the system itself encounters unforeseen circumstances. In the case, output of the first estimation device 21 may be stopped.

As described above, the control unit 11 compares determination results of these estimation devices using the first estimation device 21 for presenting information to a user and the second estimation device 24 for estimating validity of information presented based on actual reaction of the user and also when each of the determination results differs, depending on whether its cause is an environmental cause or not, a form (structure etc. of networks or nodes used in learning) of learning is changed, or the learning itself is suppressed. As a result of the, unforeseen circumstances based on accidental causes can be prevented from being learned as they are.

Incidentally, here, the first estimation device 21 or the second estimation device 24, etc. are constructed so as to generate information etc. about an importance level of electronic mail using a Bayesian network, but inference processing of other belief networks, support vector machines, cooccurrence patterns, decision making trees, etc. may be used in addition to the Bayesian network.

Also, in the learning control unit 25, variations in time of determination information or second determination information, etc. outputted by the first estimation device 21, the second estimation device 24 and the environment decision unit 23 or variations in time of nodes used by each of them are analyzed by processing of time series analysis known widely. Then, it is decided whether or not to perform learning of the first estimation device 21 or the second estimation device 24 based on the variations in time, and when it is decided that the learning is done, the learning of the first estimation device 21 or the second estimation device 24 may be done.

Here, as the variations in time, there is information about magnitude of variations, a tendency to increase or decrease an occurrence probability, a variation cycle, etc. As a specific example, when there is a tendency to increase the receiving frequency of electronic mail from a sender A (an occurrence probability that a sender of electronic mail is A increases) , the learning control unit 25 extracts only the last predetermined periods of the past learning data stored in the storage unit 12 and again learns the network of the first estimation device 21 or the second estimation device 24 based on the last past learning data extracted. As a result of the, a network better adapted for the last trend is generated.

Also, when a variation cycle is detected, the past learning data of the period exceeding the variation cycle is extracted and the network of the first estimation device 21 or the second estimation device 24 may be again learned by the past learning data extracted. In the manner, accuracy of the learning can be improved.

Incidentally, the presentation of information has been described heretofore, but service provided to a user is not limited to such providing of information, and can also be used in control of devices, for example, brightness of illumination, height of a chair, a direction, blow force, temperature of an air-conditioning device. For illumination, voltage control is performed, and for height of a chair, vertical driving etc. of a chair surface by a stepping motor are performed. The invention can also be applied to the control, and it is decided whether or not to perform learning of first estimation unit using determination information, classification result information and second determination information at the time of performing its control and by do the learning, accuracy of the learning can be improved.

Also, in a user and a device for providing service, it is unnecessary to directly operate the service to the user, for example, the same room and, for example, it may be applied to an apparatus of the case that an apparatus automatically controlled in a separate room is remotely supervised by a television monitor. In the case, reaction of a supervisor is obtained as information.

Although the present invention has been shown and described with reference to the embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. A service providing apparatus comprising:
a service providing unit that provides a service to a user;
a first estimation unit that calculates a first occurrence probability of a predetermined event about the service using a learned result that was learned based on information about the service provided in the past and an occurrence history of the predetermined event, and providing a first determination information related to the first occurrence probability to the user;
an environment decision unit that obtains information about environment of the user, classifies environment indicated by the obtained information into any of predetermined environment types according to a predetermined rule, and outputs classification result information indicating the classification result;
a second estimation unit that obtains information about reaction of the user who received the service, calculates a second occurrence probability of the predetermined event about the provided service using the learned result and the obtained information, and generates second determination information related to the second occurrence probability; and
a decision unit that decides whether or not to perform learning of the first estimation unit using the occurrence history of the predetermined event and the information about the provided service, based on the first determination information, the classification result information and the second determination information, wherein the first estimation unit performs learning using the occurrence history of the predetermined event and the provided service in accordance with a decision of the decision unit.

2. The service providing apparatus according to claim 1, wherein the first estimation unit performs processing for extracting plural predetermined learning element information from the service provided in the past and learning and acquiring a relation between the plural learning element information and the occurrence history, and
wherein the decision unit decides whether or not to perform learning of the first estimation unit using the occurrence history of the predetermined event and the provided service based on variations in time about the plural learning element information and the information outputted by each of the first estimation unit, the environment decision unit and the second estimation unit.

3. The service providing apparatus according to claim 1, wherein the second estimation unit performs processing for extracting plural predetermined learning element information from information about reaction of the user obtained in the past and learning and acquiring a relation between the plural learning element information and the occurrence history,
wherein the decision unit decides whether or not to perform learning of the second estimation unit based on variations in time about the plural learning element information and the information outputted by each of the first estimation unit, the environment decision unit and the second estimation unit, and
wherein the second estimation unit performs learning according to the decision of the decision unit.

4. The service providing apparatus according to claim 1, wherein the decision unit decides whether or not to perform learning of at least one of the first estimation unit or the second estimation unit based on variations in time of information about environment of the user obtained by the environment decision unit.

5. The service providing apparatus according to claim 1, wherein the service provided by the service providing unit is a presentation service of information, and the information about the service provided in the past includes information presented in the past.

6. A service providing method for providing predetermined service to a user, the method comprising:
calculating a first occurrence probability of a predetermined event about provided service using a learned result that was learned based on information about the service provided in the past and an occurrence history of the predetermined event;
generating first determination information related to the first occurrence probability;
obtaining information about environment of the user;
classifying environment indicated by the information about environment into any of predetermined environment types according to a predetermined rule;
generating classification result information indicating the classification result;
obtaining information about reaction of the user receiving the service;
calculating a second occurrence probability of a predetermined event about the provided service using the learned result and the information about reaction, and generating second determination information related to the second occurrence probability;
deciding whether or not to perform learning about the step of generating the first determination information based on the first determination information, the classification result information and the second determination information; and
learning about the step of generating the first determination information in accordance with a result of the decision.

7. A computer-readable program product for causing a computer system to perform procedure for providing predetermined service to a user, the procedure comprising:
calculating a first occurrence probability of a predetermined event about provided service using a learned result that was learned based on information about the service provided in the past and an occurrence history of the predetermined event;
generating first determination information related to the first occurrence probability;
obtaining information about environment of the user;
classifying environment indicated by the information about environment into any of predetermined environment types according to a predetermined rule;
generating classification result information indicating the classification result;
obtaining information about reaction of the user receiving the service;
calculating a second occurrence probability of a predetermined event about the provided service using the learned result and the information about reaction, and generating second determination information related to a result of the calculation;
deciding whether or not to perform learning about the step of generating the first determination information based on the first determination information, the classification result information and the second determination information; and
learning about the step of generating the first determination information in accordance with a result of the decision.
